(19) United States
(12) Patent Application Publication
(10) Pub. No.: US 2007/0103386 A1
(43) Pub. Date: May 10, 2007

(54) Display device assembling method and display device

(75) Inventors: Zenichiro Hara, Tokyo (JP); Noritaka Egami, Tokyo (JP); Masaaki Hiraki, Tokyo (JP); Yuusaku Saitou, Tokyo (JP); Takeshi Itadani, Tokyo (JP)

Correspondence Address: BUCHANAN, INGERSOLL & ROONEY PC, POST OFFICE BOX 1404, ALEXANDRIA, VA, 22313-1404, US

(73) Assignee: Mitsubishi Electric Corporation, Tokyo (JP)

(21) Appl. No.: 11/513,150

(22) Filed: Aug. 31, 2006

(30) Foreign Application Priority Data
Nov. 10, 2005 (JP) 2005-326198

(51) Int. Cl. G09G 5/00

(52) U.S. Cl. 345/1.1

(57) ABSTRACT

The present invention provides a display device which includes at least one module mounting frame which is mounted on a display device mounting structure, a plurality of display modules which are detachably mounted on the module mounting frame and constitute a display screen, a signal cable which has a wiring route in the inside of the module mounting frame and is detachably connected to the display modules and supplies image signals to the display modules, and a power source cable which has a wiring route in the inside of the module mounting frame and is detachably connected to the display modules thus supplying electric power to the display modules. Due to such a constitution, it is possible to realize the reduction of weight and the lowering of the manufacturing cost.

### BACKGROUND OF THE INVENTION

1. Field of the Invention

The present invention relates to an assembling method of a display device which constitutes a display screen using a plurality of display modules, and a display device which constitutes a display screen using a plurality of display modules, and more particularly to an assembling method of a display device which is preferably used outdoors and such a display device.

2. Description of the Related Art

With respect to a display device such as conventional live broadcasting large-sized outdoor display device or an advertisement large-sized display device, for example, as described in JP-A-4-110992, JP-A-2004-341468 and the like, a display screen is constituted of a plurality of display modules.

Although the whole constitutions of these structures are not shown in these publications, the typical whole constitution of the structure of the display device used outdoors such as the live broadcasting large-sized outdoor display device, the advertisement large-sized display device or the like, is shown in FIG. 22, for example.

FIG. 22 shows an example of the conventional typical large-sized display device as a right side view. As shown in the drawing, the conventional typical large-sized display device has, in general, the structure in which in the inside of a waterproof outer casing 1c having the waterproof structure, a large number of support columns 1d, a large number of display modules xx which are mounted on the large number of support columns 1d, a display controller 2 which controls a screen display on the whole display screen which is constituted of the large number of display modules xx, a power source for these parts (omitted from the drawing) and the like are incorporated.

Further, in the conventional typical large-sized display device, the weight support structure is, as can be estimated also from FIG. 22, the self-completing or self-standing structure in which the waterproof outer casing 1c receives all weights consisting of the total weight of the large number of support columns 1d, the total weight of the large number of display modules xx, the total weight of electric circuit constituting parts such as the display controller 2, the power source, various cables for electric power/control signals, and the weight of the waterproof outer casing 1c per se.

In the conventional large-sized display device, the weight support structure, as illustrated in FIG. 22, is the self-completing or self-standing structure in which the waterproof outer casing 1c receives all weights consisting of the total weight of the large number of support columns 1d, the total weight of the large number of display modules xx, the total weight of electric circuit constituting parts such as the display controller 2, the power source, various cables for electric power/control signals, and the weight of the waterproof outer casing 1c per se. Accordingly, the weight support structure has an advantage that the sufficient waterproof structure is applied to the electronic equipment in the inside of the structure and hence, the weight support structure can be installed in any arbitrary environment. On the other hand, the waterproof outer casing 1c per se is required to possess the sufficient strength and reliability thus pushing up a weight and a manufacturing cost of the whole display device.

### SUMMARY OF THE INVENTION

The present invention has been made in view of the above-mentioned circumstances and it is an object of the present invention to reduce a weight and a manufacturing cost of a display device per se.

The present invention is directed to an assembling method of a display device which constitutes a display screen using a plurality of display modules, wherein the display device is assembled by a waterproof frame mounting step which mounts a waterproof frame on a display device mounting structure, and a display screen assembling step which assembles the display screen whose periphery is covered with the waterproof frame mounted on the display device mounting structure using a plurality of display modules. Here, since a weight of the waterproof frame of the display device is received by the display device mounting structure, and a weight of the plurality of display modules which constitute the display screen is also received by the display device mounting structure and hence, a weight resistance strength of the display device per se can be reduced thus realizing the reduction of weight and the lowering of manufacturing cost of the display device per se.

Further, the present invention is directed to an assembling method of a display device which constitutes a display screen using a plurality of display modules, wherein the display device is assembled by a module mounting frame mounting step which mounts a module mounting frame on a display device mounting structure, a display module mounting step which mounts the display modules on the module mounting frame, and a display screen constituting step which constitutes the display screen using the plurality of display modules by exercising the display module mounting step plural times. Here, a weight of the module mounting frame of the display device is received by the display device mounting structure, and a weight of the plurality of display modules which constitute the display screen is also received by the display device mounting structure by way of the module mounting frame and hence, a weight resistance strength of the display device per se can be reduced thus realizing the reduction of the weight and the lowering of the manufacturing cost of the display device per se.

Further, the present invention is directed to a display device which includes at least one module mounting frame which is mounted on a display device mounting structure, a plurality of display modules which are detachably mounted on the module mounting frame and constitute a display screen, a signal cable which has a wiring route in the inside of the module mounting frame and is detachably connected to the display modules and supplies image signals to the display modules, and a power source cable which has a wiring route in the inside of the module mounting frame and is detachably connected to the display modules thus supplying electric power to the display modules. Due to such a constitution, it is possible to realize the reduction of weight, the lowering of the manufacturing cost and the waterproof of the display device per se.

The foregoing and other objects, features, aspects and advantages of the present invention will become more apparent from the following detailed description of the present invention when taken in conjunction with the accompanying drawings.

### BRIEF EXPLANATION OF DRAWINGS

FIG. 1 is a view showing an embodiment 1 of the present invention and is a block diagram showing an example of the system constitution of a display system which allows a large-sized display device to perform a display;

FIG. 2 is a view showing the embodiment 1 of the present invention and also is a view showing an example of the constitution of a display module which is a constitutional element which constitutes a display screen of the large-sized display device;

FIG. 3A and FIG. 3B are views showing the embodiment 1 of the present invention and also are views which schematically show an example of a state in which the large-sized display device is mounted on a display device mounting structure, wherein FIG. 3A is a front view and FIG. 3B is a right side view;

FIG. 4 is a view showing the embodiment 1 of the present invention and also is a longitudinal cross-sectional right side view with a part in cross section showing a cross section of a part in an enlarged manner for explaining an example of an assembling method of the large-sized display device on the display device mounting structure;

FIG. 5 is a view showing the embodiment 1 of the present invention and also is a longitudinal cross-sectional right side view with a part in cross section showing a cross section of a part in an enlarged manner for showing an example of an assembling completion state of the large-sized display device on the display device mounting structure;

FIG. 6A and FIG. 6B are views showing the embodiment 1 of the present invention and are also views showing an example of a state before display modules are assembled in the large-sized display device, wherein FIG. 6A is a front view and FIG. 6B is a right side view;

FIG. 7A and FIG. 7B are views showing the embodiment 1 of the present invention and are also views showing an example of a state after display modules are assembled in the large-sized display device, wherein FIG. 7A is a front view and FIG. 7B is a right side view;

FIG. 8 is a view showing the embodiment 1 of the present invention and is also a longitudinal cross-sectional right side view with a part in cross section which shows a portion in cross section by enlarging the example of the state before the display modules are assembled in the large-sized display device;

FIG. 9 is a view showing the embodiment 1 of the present invention and is also a longitudinal cross-sectional right side view with a part in cross section which shows a portion in cross section by enlarging the example of the state after the display modules are assembled in the large-sized display device;

FIG. 10 is a view showing the embodiment 1 of the present invention and is also a longitudinal cross-sectional front view in a state that a cross section taken along a line X-X in FIG. 8 is viewed in the direction of an arrow;

FIG. 11 is a view showing an embodiment 2 of the present invention and also is a front view showing another example of the state before the display modules are assembled in the large-sized display device;

FIG. 12 is a view showing an embodiment 3 of the present invention and also is a front view showing still another example of the state before the display modules are assembled in the large-sized display device;

FIG. 13 is a view showing an embodiment 4 of the present invention and also is a front view showing still another example of the state before the display modules are assembled in the large-sized display device;

FIG. 14 is a view showing an embodiment 5 of the present invention and also is a back view showing another example of a state in which the large-sized display device is mounted on the display device mounting structure;

FIG. 15 is a view showing an embodiment 6 of the present invention and also is a front view showing still another example of the state in which the large-sized display device is mounted on the display device mounting structure;

FIG. 16 is a view showing an embodiment 7 of the present invention and is also a partially longitudinal cross-sectional right side view showing a part in cross section of still another example of a state in which the large-sized display device is mounted on the display device mounting structure;

FIG. 17 is a view showing an embodiment 8 of the present invention and is also a right side view showing another example of the display modules which are constitutional elements constituting a display screen;

FIG. 18 is a view showing an embodiment 9 of the present invention and is also a block diagram showing another example of the system constitution of a display system which allows the large-sized display device to perform a display;

FIG. 19 is a view showing an embodiment 10 of the present invention and also is a longitudinal cross-sectional right side view with a part in cross section showing a part in cross section by enlarging an example of a display module fixing means particularly in a state before the display modules are assembled in the large-sized display device;

FIG. 20 is a view showing an embodiment 11 of the present invention and also is a longitudinal cross-sectional right side view with a part in cross section showing a part in cross section by further enlarging an example of a display module fixing means particularly in a state before the display modules are assembled in the large-sized display device;

FIG. 21A, FIG. 21B and FIG. 21C are views showing an embodiment 12 of the present invention and also are exploded of an example of another large-sized display device, wherein FIG. 21A is a front view showing a state in which a waterproof frame is disassembled, FIG. 21B is a front view of a display screen portion, and FIG. 21C is a front view sowing a state in which the waterproof frame is assembled to an outer periphery of the display screen portion; and

FIG. 22 is a right side view showing an example of a conventional typical large-sized display device.

### DESCRIPTION OF THE PREFERRED EMBODIMENTS

### Embodiment 1

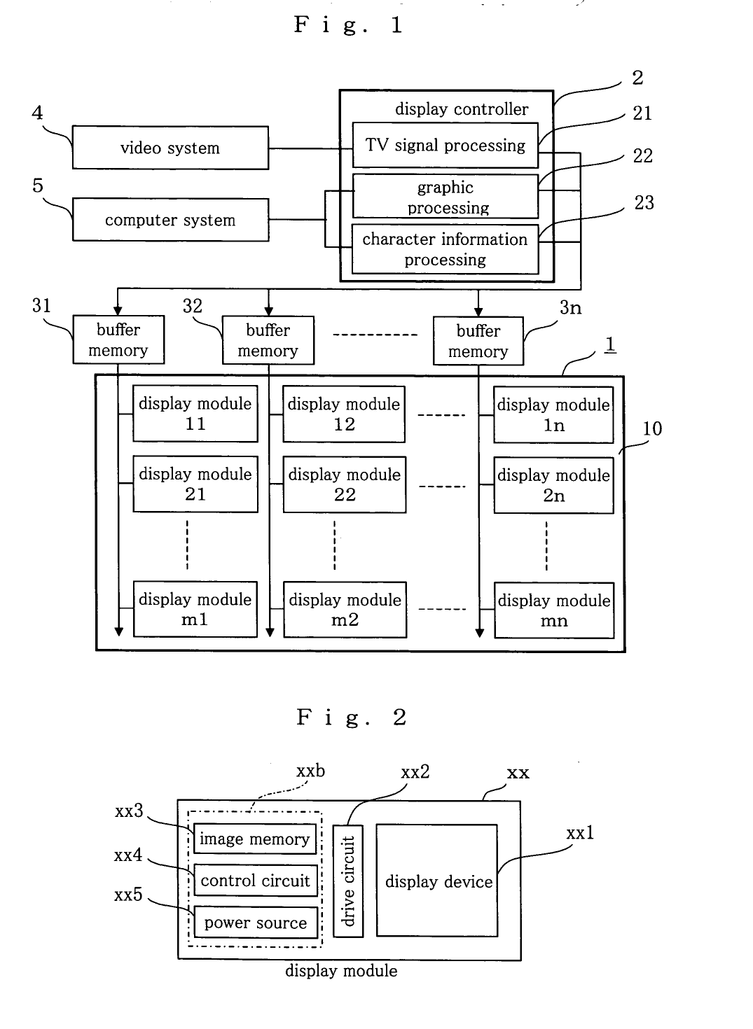

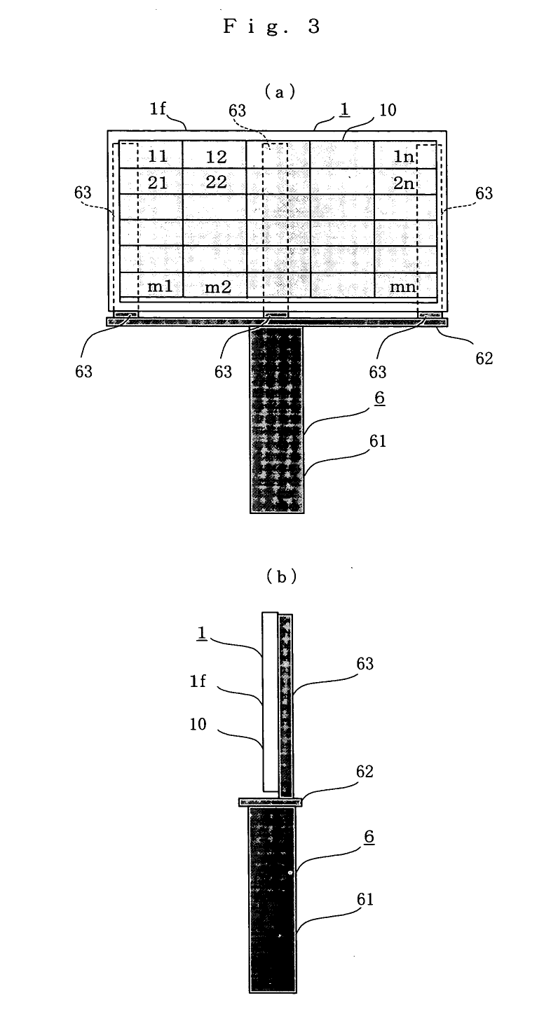

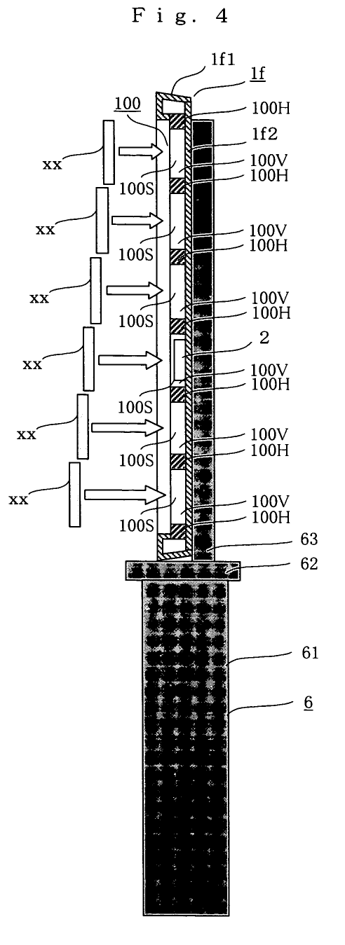

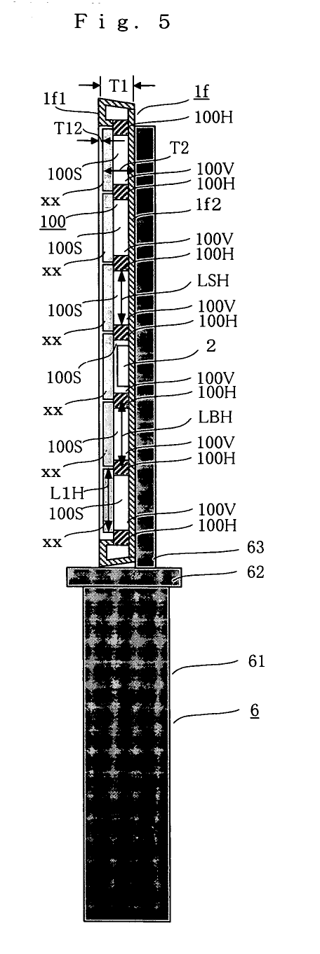

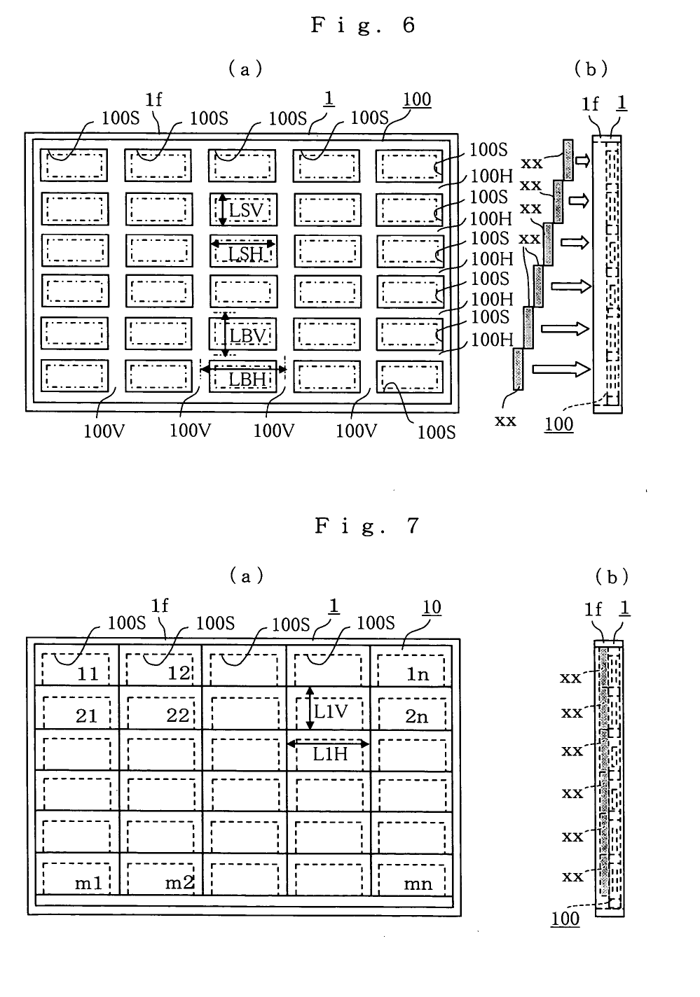

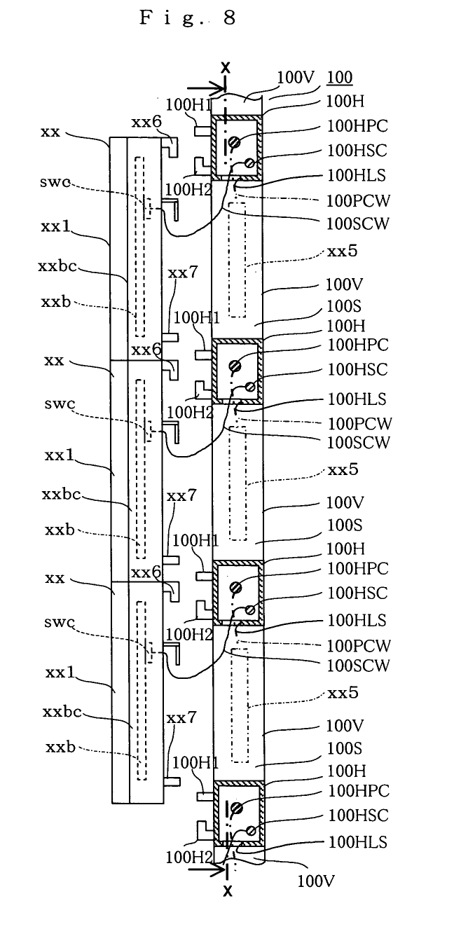

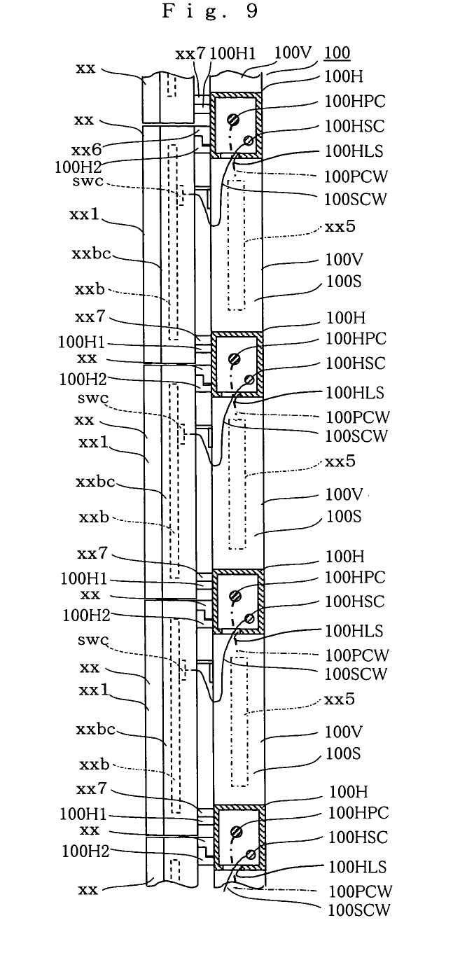

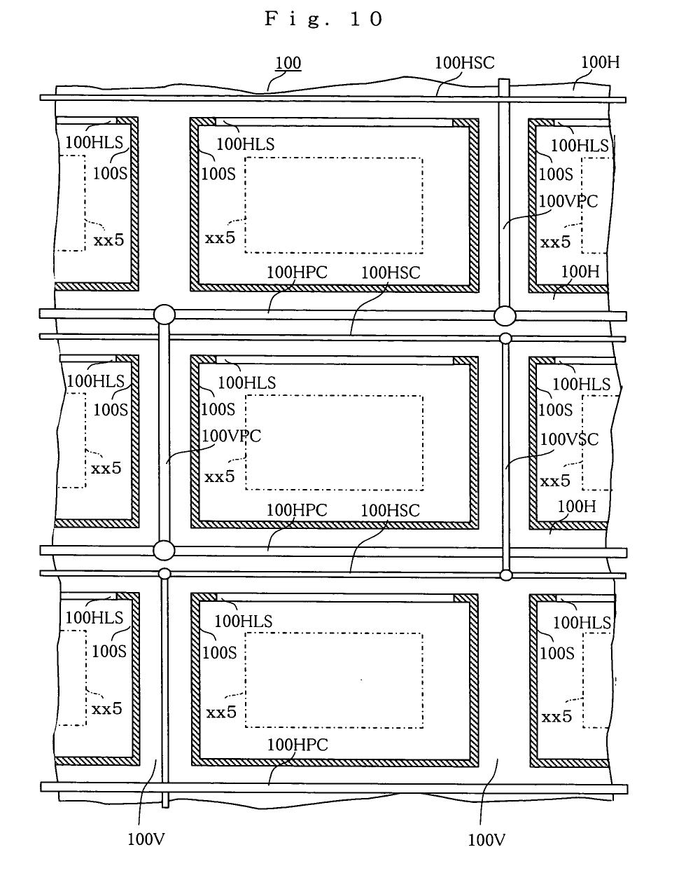

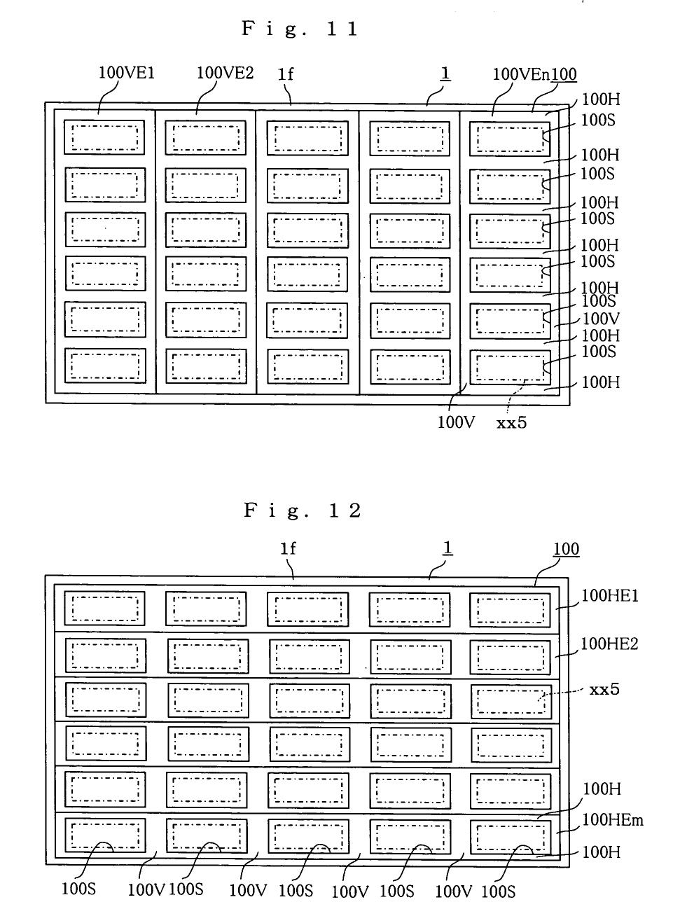

Hereinafter, an embodiment 1 of the present invention is explained in conjunction with FIG. 1 to FIG. 10. FIG. 1 is a block diagram showing an example of the system constitution of a display system which allows a large-sized display device to perform a display, FIG. 2 is a view showing an example of the constitution of a display module which is a constitutional element which constitutes a display screen of the large-sized display device, FIG. 3A and FIG. 3B are views which schematically show an example of a state in which the large-sized display device is mounted on a display device mounting structure, wherein FIG. 3A is a front view and FIG. 3B is a right side view, FIG. 4 is a longitudinal cross-sectional right side view with a part in cross section showing a cross section of a part in an enlarged manner for explaining an example of an assembling method of the large-sized display device on the display device mounting structure, FIG. 5 is a longitudinal cross-sectional right side view with a part in cross section showing a cross section of a part in an enlarged manner for showing an example of an assembling completion state of the large-sized display device on the display device mounting structure, FIG. 6A and FIG. 6B are views showing an example of a state before display modules are assembled in the large-sized display device, wherein FIG. 6A is a front view and FIG. 6B is a right side view, FIG. 7A and FIG. 7B are views showing an example of a state after display modules are assembled in the large-sized display device, wherein FIG. 7A is a front view and FIG. 7B is a right side view, FIG. 8 is a longitudinal cross-sectional right side view with a part in cross section which shows a portion in cross section by enlarging the example of the state before the display modules are assembled in the large-sized display device, FIG. 9 is a longitudinal cross-sectional right side view with a part in cross section which shows a portion in cross section by enlarging the example of the state after the display modules are assembled in the large-sized display device, and FIG. 10 is a longitudinal cross-sectional front view in a state that a cross section taken along a line X-X in FIG. 8 is viewed in the direction of an arrow. In these drawings, same symbols indicate identical portions.

Hereinafter, the embodiment is explained in order of these drawings.

A display system which allows a large-sized display device used in the embodiment 1 of the present invention to perform a display is not a particular system and is a display system which has been used generally conventionally for allowing a large-sized display device whose display screen is constituted of a plurality of display modules such as a live broadcasting large-sized outdoor display device, an advertisement large-sized display device or the like to perform a display can be used. With respect to the display system which has been generally used conventionally, various systems have been considered specifically. As the system constitution of one example out of these respective systems, an example of the display system in the embodiment 1 of the present invention is shown in FIG. 1.

With respect to the display system shown in FIG. 1, as illustrated in the drawing, in the display device 1, a display screen 10 is, as is well known, constituted by arranging a large number of display modules 11, 12, . . . 1n, 21, 22, . . . 2n, . . . m1, m2, . . . mn in a matrix array, that is, in the row direction (lateral direction) and in the column direction (longitudinal direction).

In the display device 1 having such a constitution, as is well known, an image display control signal and an image information signal are supplied from a display controller 2 by way of buffer memories 31, 32, . . . 3n formed for every row.

The above-mentioned display controller 2 possesses, as is well known, a function 21 of TV (television) signal processing which processes image information from a video system 4, a function 22 of graphic processing which processes image information from a computer system 5, and a function 23 of character information processing which processes character information from the computer system 5. As is well known, the controller 2, based on information from the video system 4 and information from the computer system 5, supplies predetermined image display control signals and image information signals to the display modules 11, 12, . . . 1n, 21, 22, . . . 2n, . . . m1, m2, . . . mn of the display device 1 so as to allow the whole display screen 10 to display a predetermined image such as a live broadcasting image or an advertisement image (containing characters).

As the display modules 11, 12, . . . 1n, 21, 22, . . . 2n, . . . m1, m2, . . . mn, a display module xx having the same constitution is used. For example, as shown in FIG. 2 which shows one example of the well-known constitution, the display module xx is constituted of a display device xx1 which is constituted of a plurality of pixels, a drive circuit xx2 which drives the display device xx1, an image memory xx3 which temporarily or fixedly stores information on images displayed on the display device xx1, a control circuit xx4 which allows the display device xx1 to display predetermined images, and a power source xx5.

Further, the drive circuit xx2, the image memory xx3 and the control circuit xx4 are formed on a common substrate xxb, and are mounted on a back surface side of the display device xx1 as the waterproof structure (see FIG. 8 and FIG. 9 described later).

The display device xx1 is a well-known display device. With respect to the display device, originally, a system which arranges cathode ray tubes (CRT) of single color is put into practice. Thereafter, by applying principles of a CRT and a discharge tube, a display device which arranges a plurality of pixels in the inside of the display device xx1 is developed and hence, the resolution is remarkably improved. A system which arranges LCD (liquid crystal) is put into practice, and a system which arranges a PDP (plasma display play) or a VFD (phosphorus display tube) is manufactured on a trial basis. In this manner, it becomes possible to use various kinds of display devices xx1 for the large-sized display device application. Recently, the system which arranges LED (light emitting diodes) becomes a main stream, while the large-sized display device copes with various applications such as the indoor high-resolution application, the outdoor ultra brightness application, the light-weighted and thin building wall surface application and the like. When the LED is used, a plurality of LED is arranged thus forming the display module xx having the panel-like constitution.

In each display module 11, 12, . . . 1n, 21, 22, . . . 2n, . . . m1, m2, . . . mn, a portion of the image which is allocated corresponding to a size of the module is displayed thus displaying one image as a whole on the display screen 10. Accordingly, when the display screen 10 is observed from a front side of the display screen 10, the respective display modules 11, 12, . . . 1n, 21, 22, . . . 2n, . . . m1, m2, . . . mn are arranged relatively close to each other to prevent the clearance between the respective display modules, that is, to prevent the clearance between the display devices xx1 from becoming apparent like tile joints.

The power source xx5 may be arranged outside the display module xx in place of arranging the power source xx5 inside the display module xx. Further, the power source xx5 supplies electric power to the display device xx1, the drive circuit xx2, the image memory xx3 and the control circuit xx4.

FIG. 3 shows a state in which the display device 1 is mounted on the display device mounting structure 6.

In the embodiment 1 of the present invention, the display device mounting structure 6 is an existing mounting base and is constituted of a fixed leg portion 61, a base plate 62 mounted on the leg portion 61, and a plurality of support struts 63, 63, 63 which are mounted in an erected manner on the base plate 62 in a spaced-apart manner. Then, the display device 1 is mounted on the plurality of support struts 63, 63, 63.

In the display device 1, as described above, the display screen 10 is constituted of the large number of display modules 11, 12, . . . 1n, 21, 22, . . . 2n, . . . m1, m2, . . . mn which are arranged in a matrix array as described above. The display screen 10 which is constituted of the large number of display modules 11, 12, . . . 1n, 21, 22, . . . 2n, . . . m1, m2, . . . mn which are arranged in a matrix array is mounted on the display device mounting structure 6 by way of a waterproof frame 1f.

The detailed structure of FIG. 3B is indicated in FIG. 5 which is an enlarged view. FIG. 5 is a view showing a result of assembling and an assembling step is shown in FIG. 4.

In FIG. 3, FIG. 4 and FIG. 5, the waterproof frame 1f of the display device 1 is constituted of a back plate 1f1 having a rectangular shape as viewed from a front side and a waterproof frame body 1f2 which is integrally mounted on the whole periphery of the back plate 1f1 in a picture-frame-like shape.

Here, FIG. 4 which is the view showing the assembling step, the waterproof frame 1f is mounted on the support struts 63, 63, 63 of the display device mounting structure 6 using general mounting means such as screwing using bolts or the like. This step is a waterproof frame mounting step which mounts the waterproof frame if on the display device mounting structure 6.

After mounting the waterproof frame 1f on the display device mounting structure 6 (that is, after the above-mentioned waterproof frame mounting step), on a front side of the back plate 1f1 of the waterproof frame 1f, a module mounting frame 100 having a grid shape as viewed from a front side is mounted by screwing or using other general mounting means. After mounting the module mounting frame 100 on the waterproof frame 1f, the large number of display modules xx (see FIG. 2) are sequentially mounted on the module mounting frame 100 which is mounted on the waterproof frame 1f as indicated by an arrow thus assembling the display screen 10 which is constituted of the display modules 11, 12, . . . 1n, 21, 22, . . . 2n, . . . m1, m2, . . . mn arranged in a matrix array. This step is referred to as a display screen assembling step in which the display screen 10 which has the periphery thereof covered with the waterproof frame if mounted on the display device mounting structure 6 is assembled using the plurality of display modules xx (see FIG. 2).

The result of the completion of this display screen assembling step is shown in FIG. 5.

As shown in FIG. 5, in a state that the display screen assembling step is completed, the relationship between a thickness T1 in the depth direction (longitudinal direction as viewed from the front side) of the waterproof frame body 1f2 and a total thickness T2 in the above-mentioned depth direction of the module mounting frame 100, the display module xx and the back plate 1f1 which are assembled in the above-mentioned manner is set as T1>T2. That is, as shown in the drawing, this embodiment adopts the structure in which the waterproof frame body 1f2 projects toward the front side from a front-side surface of the display screen 10 by a size T12. Due to such a structure, it is possible to suppress or prevent the intrusion of rains or the intrusion of dusts between the waterproof frame if and the module mounting frame 100 as well as between the module mounting frame 100 and the display module xx.

Here, the above-mentioned grid-like module mounting frame 100 includes a plurality of longitudinal beams 100V the number of which corresponds to the number of the display modules xx, a plurality of lateral beams 100H the number of which corresponds to the number of the display modules xx, and a plurality of rectangular parallelepiped spaces 100S which are surrounded by these longitudinal beams 100V and the lateral beams 100H. The relationship among a length L1V in the up-and-down direction (vertical direction) of the display modules xx (the above-mentioned display devices xx1), an inter-beam size LBV of the plurality of lateral beams 100H, and a length LSV in the up-and-down direction (vertical direction) of the space 100S is set as LBV>L1V>LSV over the whole width in the lateral direction as viewed from the front side of the display module XX.

In the same manner, the relationship among a length L1H (see FIG. 7A) in the left-and-right direction (horizontal direction) of the display modules xx (the above-mentioned display devices xx1), an inter-beam size LBH (see FIG. 6A) of the plurality of longitudinal beams 100V, and a length LSH (see FIG. 6A) in the left-and-right direction (horizontal direction) of the space 100S is set as LBH>L1H>LSH over the whole width in the longitudinal direction as viewed from the front side of the display module XX (the above-mentioned display device xx1).

Here, before the above-mentioned step in which the large number of display modules xx are mounted on the module mounting frame 100, the display controller 2 is assembled to the inside of any one arbitrary space out of the above-mentioned large number of spaces 100S.

By adopting the structure in which the above-mentioned relationships LBV>L1V>LSV and LBH>L1H>LSH are established, it is possible to obtain the display device 1 in which a gap between the above-mentioned display modules xx (the above-mentioned display devices xx1) is small and an end portion of the above-mentioned display module xx can be firmly mounted on the module mounting frame 100. Further, the display device mounting structure 6 receives a weight of the waterproof frame if of the display device 1 and, at the same time, the display device mounting structure 6 also receives weights of the plurality of display modules 11, 12, . . . 1n, 21, 22, . . . 2n, . . . m1, m2, . . . mn which constitute the display screen 10 and hence, a weight resistance strength of the display device 1 per se can be reduced thus realizing the reduction of weight of and the lowering of manufacturing cost of the display device 1 per se.

Here, FIG. 6 and FIG. 7 are views which illustrate only the display device 1 without illustrating the display device mounting structure 6. As mentioned previously, FIG. 6 is the view showing the example of the state before the display module xx is assembled in the large-sized display device, and FIG. 7 is the view showing an example of a state in which the display module xx is assembled. FIG. 6B is a right side view corresponding to FIG. 4, wherein a predetermined number of display modules xx, xx, . . . are, in the same manner as the explanation made in conjunction with FIG. 4, sequentially assembled in the above-mentioned module mounting frame 100 as indicated by an arrow.

An example of the mounting structure (means) which mounts the display modules xx on the module mounting frame 100 is illustrated in FIG. 8 and FIG. 9.

As shown in FIG. 8 and FIG. 9, on a front-side surface of each lateral beam 100H of the module mounting frame 100, a tongue-like first engaging member 100H1 which projects horizontally and an upwardly-directed hook-like (L-shaped) second engaging member 100H2 are formed. The first engaging member 100H1 is spaced apart from the second engaging member 100H2 and is positioned above the second engaging member 100H2.

As shown in FIG. 8 and FIG. 9, with respect to each display module xx, on a back side of the display device xx1 having the waterproof structure on a front side thereof, a waterproof casing which incorporates the common substrate xxb on which the drive circuit xx2, the image memory xx3, the control circuit xx4 and the like are formed and waterproof coating xxbc such as resin molding are integrally formed with the display device xx1. A downwardly-directed hook-like (L-shaped) third engaging member xx6 is mounted on an upper end portion of a back surface of the waterproof coating xxbc, while a tongue-like fourth engaging member xx7 which projects horizontally is mounted on a lower end portion of the back surface of the waterproof coating xxbc.

Further, as shown in FIG. 8 and FIG. 9, each lateral beam 100H of the module mounting frame 100 has the hollow structure and the inside of each hollow lateral beam 100H is used as a wiring route for a power source cable 100HPC and a signal cable 100HSC. Electric power is supplied to the power sources xx5 of the respective display modules xx from the power source cable 100HPC, while image control signals and image information signals are supplied to the respective display modules xx from the signal cable 100HSC.

The power source cable 100HPC is detachably connected with the power source xx5 of each display module xx via a power source connecting line 100PCW which passes a through hole 100HLS formed in a lower-side surface of each lateral beam 100H of the module mounting frame 100 using a compression bonding terminal or the like.

In the same manner, the signal cable 100HSC is detachably connected with the common substrate xxb of each display module xx5 via the signal connecting line 100SCW which passes a through hole 100HLS formed in the lower-side surface of each lateral beam 100H of the module mounting frame 100 using a commercially available connector.

The power source xx5 of each display module xx is arranged in the inside of the space 100S defined in the inside of the module mounting frame 100 to which each display module xx corresponds.

The power source xx5 of each display module xx in the inside of the space 100S and the power source cable 100HPC in the inside of the module mounting frame 100 are connected with each other by way of the above-mentioned power source connecting line 100PCW, while the substrate xxb in the inside of each display module xx in the inside of the space 100S and the signal cable 100HSC in the inside of the module mounting frame 100 are connected with each other by way of the signal connecting line 100SCW. Thereafter, a downwardly extending hook-shaped (L-shaped) third engaging member xx6 of the display module xx is engaged with the upwardly extending hook-shaped (L-shaped) second engaging member 100H2 of the module mounting frame 100 thus shifting an operational state from the state shown in FIG. 8 to the state shown in FIG. 9.

When the display module xx is assembled due to the engagement of the second engaging member 100H2 and the third engaging member xx6, as shown in FIG. 9, the tongue-like first engaging member 100H1 of the module mounting frame 100 and the tongue-like fourth engaging member xx7 of the display module xx assume an overlapped state.

By fixing the first engaging member 100H1 and the fourth engaging member xx7 in the overlapped state to each other using a fixing means such as screws when necessary, there is no possibility that the display module xx is inadvertently removed from the module mounting frame 100 due to wind or other factors.

Here, as shown in FIG. 10, the respective power source cables 100HPC and the respective signal cables 100HSC in the inside of the respective lateral beams 100H are connected with each other in the inside of the longitudinal beams 100V.

The embodiment 1 of the present invention is, as described above, directed to the assembling method of the display device 1 which constitutes the display screen 10 using a plurality of display modules xx, xx, . . . , wherein the display device is assembled by the waterproof frame mounting step which mounts the waterproof frame 1f on the display device mounting structure 6, and the display screen assembling step which assembles the display screen 10 whose periphery is covered with the waterproof frame 1f mounted on the display device mounting structure 6 using the plurality of display modules xx, xx, . . . .

Further, in the embodiment 1 of the present invention, as described above, the respective display modules xx, xx, . . . are detachably mounted on the waterproof frame 1f by way of the module mounting frame 100.

Further, the embodiment 1 of the present invention is, as described above, directed to the assembling method of the display device 1 which constitutes the display screen using the plurality of display modules xx, xx, . . . , wherein the display device 1 is assembled by the module mounting frame mounting step which mounts the module mounting frame 100 on the display device mounting structure 6, a display module mounting step which mounts the display modules xx, xx, . . . on the module mounting frame 100, and the display screen constituting step which constitutes the display screen 10 using the plurality of display modules xx, xx, . . . by exercising the display module mounting step plural times.

Further, in the embodiment 1 of the present invention, as described above, the present invention is directed to the display device which includes at least one module mounting frame 100 which is mounted on the display device mounting structure 6, the plurality of display modules xx, xx, . . . which are detachably mounted on the module mounting frame 100 and constitute the display screen 10, the signal cable 100HSC which has the wiring route in the inside of the module mounting frame 100 and is detachably connected to the display modules xx, xx, . . . and supplies image signals to the display modules, and the power source cable 100HPC which has the wiring route in the inside of the module mounting frame 100 and is detachably connected to the display modules xx, xx. . . . thus supplying electric power to the display modules xx, xx.

Further, in the embodiment 1 of the present invention, as mentioned previously, the module mounting frame 100 is constituted of a grid-like frame and the plurality of display modules xx, xx, . . . are detachably mounted on the beams 100H of the module mounting frame 100.

### Embodiment 2

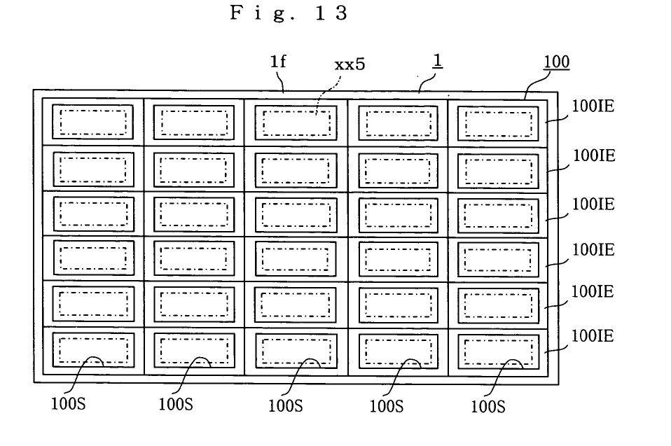

Hereinafter, an embodiment 2 of the present invention is explained in conjunction with FIG. 11. FIG. 11 is a front view showing another example of a state before display modules are assembled to a large-sized display device. In FIG. 11, parts which are identical with or correspond to the above-mentioned parts shown in FIG. 1 to FIG. 10 are given same symbols. Hereinafter, points which make this embodiment 2 different from the above-mentioned embodiment 1 shown in FIG. 1 to FIG. 10 are mainly explained.

FIG. 11 is a view which corresponds to FIG. 6A described above, and shows particularly another example of the above-mentioned module mounting frame 100. That is, in the above-mentioned FIG. 6A, the example in which one grid-like module mounting frame 100 is used as the module mounting frame 100 is illustrated. In FIG. 11, as illustrated in the drawing, a predetermined number of ladder-like module mounting frame constitutional elements 100VE1, 100VE2, . . . , 100VEn which extend in the up-and-down direction (vertical direction or columnar direction) are arranged in the lateral direction (horizontal direction or row direction) to constitute a module mounting frame 100 having a predetermined area.

By adopting the structure which constitutes the module mounting frame 100 having the predetermined area by arranging the predetermined number of ladder-like module mounting frame constitutional elements 100VE1, 100VE2, . . . , 100VEn in the lateral direction (horizontal direction), particularly with respect to the large sized display device having longitudinal and lateral sizes of several meters, compared to one grid-like module mounting frame, a unit which becomes an object to be handled in the assembling operation can be miniaturized and light-weighted and hence, the unit becomes extremely light-weighted compared to the conventional self-standing display device whereby the operability and the safety of an operation to mount the module mounting frame 100 to the display device mounting structure 6 (omitted from FIG. 11) are enhanced and, at the same time, a weight which is applied to mounting bolts or other mounting means for mounting the module mounting frame on the display device mounting structure 6 (omitted from FIG. 11) can be decreased and the manufacturing cost can be more lowered.

### Embodiment 3

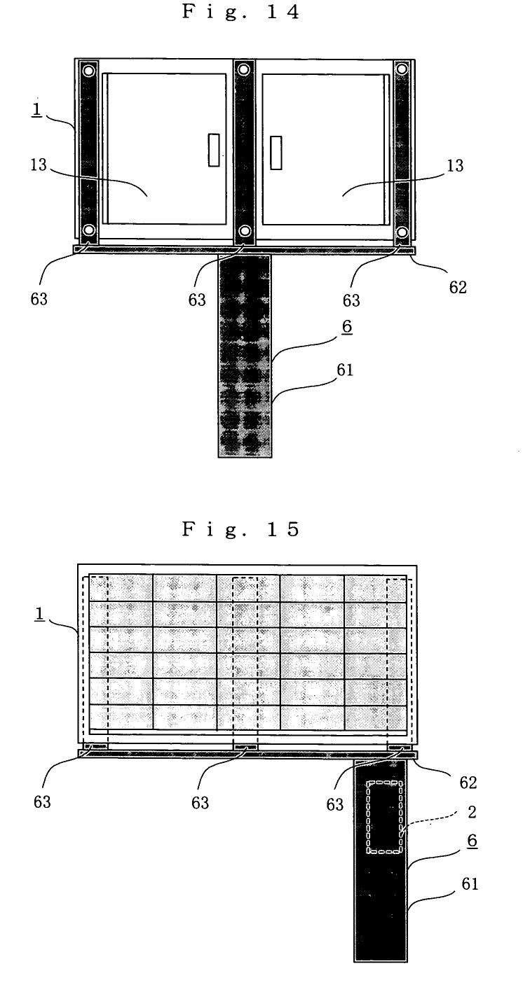

Hereinafter, an embodiment 3 of the present invention is explained in conjunction with FIG. 12. FIG. 12 is a front view showing another example of a state before display modules are assembled to a large-sized display device. In FIG. 12, parts which are identical with or correspond to the above-mentioned parts shown in FIG. 1 to FIG. 11 are given same symbols. Hereinafter, points which make this embodiment 3 different from the above-mentioned embodiments 1 and 2 shown in FIG. 1 to FIG. 11 are mainly explained.

FIG. 12 is a view which corresponds to FIG. 6A and FIG. 11 described above, and shows particularly another example of the above-mentioned module mounting frame 100. That is, in the above-mentioned FIG. 6A, the example in which one grid-like module mounting frame 100 is used as the module mounting frame 100. In FIG. 12, as illustrated in the drawing, a predetermined number of ladder-like module mounting frame constitutional elements 100HE1, 100HE2, . . . , 100HEm which extend in the left-and-right lateral direction (horizontal direction or row direction) is arranged in the longitudinal direction (vertical direction or columnar direction) to constitute a module mounting frame 100 having a predetermined area.

By adopting the structure which constitutes the module mounting frame 100 having the predetermined area by arranging the predetermined number of ladder-like module mounting frame constitutional elements 100HE1, 100HE2, . . . , 100HEm in the longitudinal direction (vertical direction), in the same manner as the case of the above-mentioned example shown in FIG. 11, particularly with respect to the large sized display device having longitudinal and lateral sizes of several meters, compared to one grid-like module mounting frame, a unit which becomes an object to be handled in the assembling operation can be miniaturized and light-weighted and hence, the unit becomes extremely light-weighted compared to the conventional self-standing display device whereby the operability and the safety of an operation to mount the module mounting frame 100 to the display device mounting structure 6 (omitted from FIG. 12) are enhanced and, at the same time, a weight which is applied to mounting bolts or other mounting means for mounting the module mounting frame on the display device mounting structure 6 (omitted from FIG. 12) can be decreased and the manufacturing cost can be more lowered.

### Embodiment 4

Hereinafter, an embodiment 4 of the present invention is explained in conjunction with FIG. 13. FIG. 13 is a front view showing another example of a state before display modules are assembled to a large-sized display device. In FIG. 13, parts which are identical with or correspond to the above-mentioned parts shown in FIG. 1 to FIG. 12 are given same symbols. Hereinafter, points which make this embodiment 4 different from the above-mentioned embodiments 1 to 3 shown in FIG. 1 to FIG. 12 are mainly explained.

FIG. 13 is a view which corresponds to FIG. 6A, FIG. 11 and FIG. 12 described above, and shows particularly another example of the above-mentioned module mounting frame 100. That is, in the above-mentioned FIG. 6A, the example in which one grid-like module mounting frame 100 is used as the module mounting frame 100 is illustrated, while in FIG. 11 and FIG. 12, the example in which ladder-like module mounting frame constitutional elements 100VE1, 100VE2, . . . , 100VEn, 100HE1, 100HE2, . . . , 100HEm are used as the module mounting frame 100 is illustrated. In FIG. 13, as shown in the drawing, picture-frame-like module mounting frame constitutional elements 100IE, 100IE, . . . 100IE are provided in a state that these module mounting frame constitutional elements 100IE, 100IE, . . . 100IE individually face the above-mentioned respective display modules 11, 12, . . . 1n, 21, 22, . . . 2n, . . . m1, m2, . . . mn. That is, in this embodiment, the number of module mounting frame constitutional elements, 100IE, 100IE, . . . 100IE is equal to the number of the above-mentioned respective display modules 11, 12, . . . 1n, 21, 22, . . . 2n, . . . m1, m2, . . . mn.

In this meaner, by adopting the structure which provides the picture-frame-like module mounting frame constitutional elements, 100IE, 100IE, . . . 100IE which individually face the above-mentioned respective display modules, 11, 12, . . . 1n, 21, 22, . . . 2n, . . . m1, m2, . . . mn, it is possible to constitute the display screen 10 having an arbitrary area larger than the areas of display screens 10 in the examples shown in FIG. 11 and FIG. 12 which use the ladder-like module mounting frame constituting members 100VE1, 100VE2, . . . , 100VEn, 100HE1, 100HE2, . . . , 100HEm. Further, this embodiment can also easily constitute the display screen 10 having an arbitrary shape.

### Embodiment 5

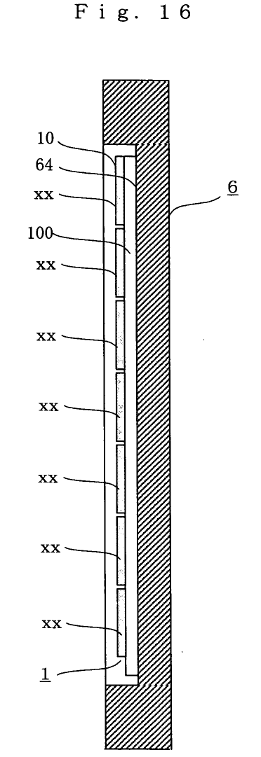

Hereinafter, an embodiment 5 of the present invention is explained in conjunction with FIG. 14. FIG. 14 is a back view showing another example of a state in which the large-sized display device is mounted on the display device mounting structure. In FIG. 14, parts which are identical with or correspond to the above-mentioned parts shown in FIG. 1 to FIG. 13 are given same symbols. Hereinafter, points which make this embodiment 5 different from the above-mentioned embodiments 1 to 4 shown in FIG. 1 to FIG. 13 are mainly explained.

FIG. 14 is a back view which corresponds to the above-mentioned FIG. 3A. In the example shown in FIG. 14, as shown in the drawing, maintenance doors 13 are mounted on a back surface side of the display device 1, wherein the inside of the display device 1 is exposed from the back side by opening the maintenance doors 13 and hence, the maintenance such as the inspection of the inside of the display device 1 can be properly conducted without removing the above-mentioned display modules on the front side (omitted from FIG. 14).

### Embodiment 6

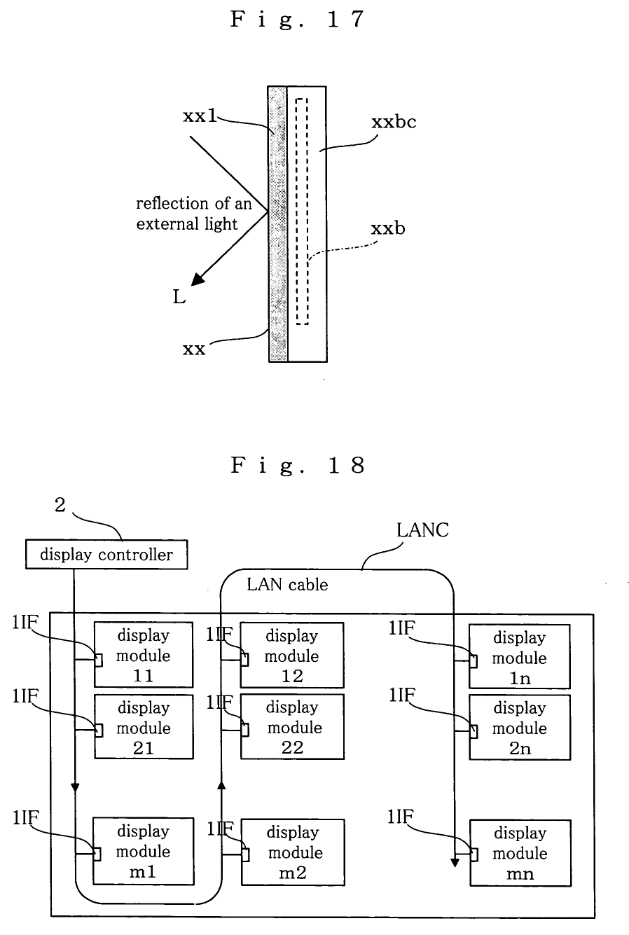

Hereinafter, an embodiment 6 of the present invention is explained in conjunction with FIG. 15. FIG. 15 is a front view showing still another example of a state in which the large-sized display device is mounted on the display device mounting structure. In FIG. 15, parts which are identical with or correspond to the above-mentioned parts shown in FIG. 1 to FIG. 14 are given same symbols. Hereinafter, points which make this embodiment 6 different from the above-mentioned embodiments 1 to 5 shown in FIG. 1 to FIG. 14 are mainly explained.

FIG. 15 is a front view which corresponds to the above-mentioned FIG. 3A. In the example shown in FIG. 15, as shown in the drawing, the display device 1 having the structure in which one end in the lateral direction of the display device 1 as viewed from a front side is supported on a leg portion 61 is illustrated. As described above, since the display device 1 per se can have the light-weighted constitution, the display device 1 can be mounted in such a design. Further, as shown in the drawing, by incorporating the above-mentioned display controller 2 (see FIG. 1) in the inside of the leg portion 61, the display device 1 can be made further light-weighted.

### Embodiment 7

Hereinafter, an embodiment 7 of the present invention is explained in conjunction with FIG. 16. FIG. 16 is a longitudinal cross-sectional right side view with a part in cross-section which shows still another example of a state in which the large-sized display device is mounted on the display device mounting structure with a part in cross-section. In FIG. 16, parts which are identical with or correspond to the above-mentioned parts shown in FIG. 1 to FIG. 15 are given same symbols. Hereinafter, points which make this embodiment 7 different from the above-mentioned embodiments 1 to 6 shown in FIG. 1 to FIG. 15 are mainly explained.

FIG. 16 is a partially longitudinal cross-sectional right side view with a part in cross-section which corresponds to the above-mentioned FIG. 4. In the example shown in FIG. 16, the display device mounting structure 6 is constituted of a wall of a building, wherein the module mounting frame 100 is mounted on a wall surface 64 of the wall, and the display modules xx, xx, . . . xx are mounted on a front side of the module mounting frame 100 which is mounted on the wall surface 64.

The building has a relatively sufficient strength with respect to the display device and the display modules xx, xx, . . . xx are assembled to the wall surface 64 as tiles and hence, it is possible to realize a wall surface display device having the stable structure. Further, it is possible to provide unique applications by changing the color of the wall or by displaying information on the wall.

There may be a case that the large-sized display device is, as illustrated and described in conjunction with FIG. 1, required to possess the display controller 2 and the plurality of control boards which control specified display module groups as the buffer memories 31, 32, . . . , 3n between the display modules. Further, there may be a case that it is necessary to provide the power sources xx5 for the plurality of respective display modules. These boards and power sources can be arranged in the inside of the space 100S in the inside of the module mounting frame 100 as described above. Although the display controller 2 and the power sources which control the whole display device 1 maybe embedded in the wall surface 64, the display controller 2 and the power sources may be arranged in the inside of the building, while the power source cables and simple-interface signal cables may be supplied to the display device 1 on the wall surface 64 from the inside of the building.

### Embodiment 8

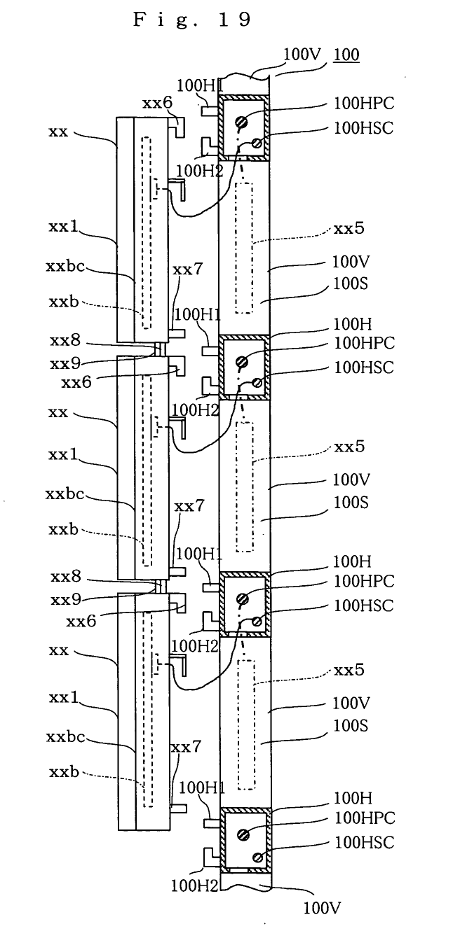

Hereinafter, an embodiment 8 of the present invention is explained in conjunction with FIG. 17. FIG. 17 is a right side view which shows another example of the display module which is the constitutional element constituting the display screen. In FIG. 17, parts which are identical with or correspond to the above-mentioned parts shown in FIG. 1 to FIG. 16 are given same symbols. Hereinafter, points which make this embodiment 8 different from the above-mentioned embodiments 1 to 7 shown in FIG. 1 to FIG. 16 are mainly explained.

In the above-mentioned embodiment 7, the present invention is applied to various kinds of planar display device xx1 (see FIG. 2). When the self-luminous display device is used outside in general, however, to obtain the practically available image under sunbeams, the high brightness becomes necessary. Particularly, when the brightness of the display device xx1 is high, a heat value is increased and hence, in the display device having the structure in which the display module xx is embedded in the wall surface 64 of the building, means which suppresses the temperature elevation or a cooling means becomes important. In case of the self-luminous display device xx1 which generates heat, when the cooling means is provided to the inside of the display device xx1, particularly when the cooling means cools the display device using air, it is necessary to ensure a flow passage for cooling air and hence, a thickness of a display part is increased.

Here, in the embodiment 8 of the present invention, a reflective display device is used as the display device xx1. The reflective display device xx1, as indicated by an arrow L in FIG. 6, performs a display by reflecting an external light (sunbeams at day time and illumination light or the like at night) and hence, the generation of heat is hardly recognized whereby it is possible to realize a thin display device with low power consumption which requires no cooling means. Particularly, when the reflective display device uses cholesteric liquid crystal, the reflective type display device exhibits an excellent advantage that the display can be maintained even when the power source is cut and hence, a wall surface which functions as the display device of low power consumption can be realized. Although the wall surface of the building is exposed to the sunbeams, the display device can obtain the sufficient luminance and hence, the reflective display device can also obtain the high image quality.

### Embodiment 9

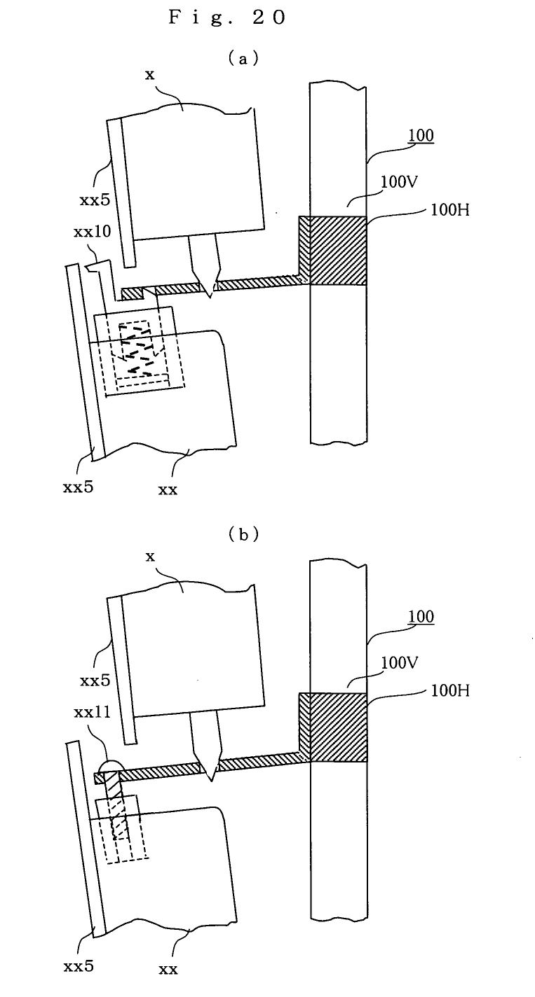

Hereinafter, an embodiment 9 of the present invention is explained in conjunction with FIG. 18. FIG. 18 is a block diagram showing another example of the system constitution of the display system which allows the large-sized display device to perform a display. In FIG. 18, parts which are identical with or correspond to the above-mentioned parts shown in FIG. 1 to FIG. 17 are given same symbols. Hereinafter, points which make this embodiment 9 different from the above-mentioned embodiments 1 to 8 shown in FIG. 1 to FIG. 17 are mainly explained.

In the above-mentioned respective embodiments, the present invention is also applicable to the display of images having large information quantity such as television signals. Accordingly, the signal lines which pass through the beams 100H, 100H, . . . 100V, 100V, . . . of the above-mentioned module mounting frame 100 are used for the parallel transmission using flat cables or the serial transmission of large capacity such as optical cables. On the other hand, there may be a case that the wall-surface information display device may perform a display of small information quantity such as the application in which the information display device is exclusively used for still images. An example which is applicable to such a case is illustrated in FIG. 18. FIG. 18 shows the case in which the respective display modules are connected with each other using a LAN cable LANC. By providing an interface 1IF of LAN to each display module, it is possible to transfer the image data using the LAN cable LANC and hence, the wiring and the system constitution can be simplified. Further, compared to the general wiring such as flat cables, this embodiment can also simplify the structure and hence, this embodiment is advantageous in the wiring in a narrow space.

### Embodiment 10

Hereinafter, an embodiment 10 of the present invention is explained in conjunction with FIG. 19. FIG. 19 is a longitudinal cross-sectional right side view with a part in cross section showing a part in cross section by enlarging an example of a display module fixing means particularly in a state before the display modules are assembled in the large-sized display device. In FIG. 19, parts which are identical with or correspond to the above-mentioned parts shown in FIG. 1 to FIG. 18 are given same symbols. Hereinafter, points which make this embodiment 10 different from the above-mentioned embodiments 1 to 9 shown in FIG. 1 to FIG. 18 are mainly explained.

FIG. 19 is the partially longitudinal cross-sectional right side view with a part in cross section which corresponds to the above-mentioned FIG. 8 and FIG. 9. FIG. 19 illustrates the structure in which, with respect to the display modules xx which are arranged close to each other, a screwing part xx8 of one display module xx and a screwing part xx9 of another display module xx are screwed.

FIG. 19 illustrates an example of the duplicate mounting structure which uses the mounting based on the engagement between the engaging member xx6 and the engaging member 100H2 described previously in conjunction with FIG. 8 and FIG. 9 and the mounting based on screwing of the screw parts xx8, xx9 in combination.

With respect to the display device which is formed on the wall surface of the building, when the display module is troubled, it is necessary to perform the maintenance which exchanges and repairs the display module from a front surface side. Here, by providing mechanical parts which are necessary for the detachment of the display module which is accessible from the front surface side of the display device to a joint portion between the modules, it is possible to realize the easy replacement operation. In the large-sized display device, in general, the joint between the display modules is designed to have a minimum width to make the joint inconspicuous. For example, in JP-A-2004-341468, an example in which display devices are arranged in an overlapped manner so as to make lead portions of electrodes inconspicuous is disclosed. However, this example has a drawback with respect to a fixing method of panels. That is, it is necessity to mount connecting pins on the panels. As in the case of the application described in this embodiment where the display device is used in a state that the display device is mounted on the wall of the building or the like, it is possible to ensure a sufficient viewing distance and hence, the influence of joints to image quality is small. Accordingly, by making use of the joint portion, it is possible to firmly fix the display module xx to the module mounting frame 100 from the front surface side and, at the same time, it is possible to easily and detachably mount the display module xx on the module mounting frame 100.

In FIG. 19, first of all, the display module xx is easily and detachably mounted on the module mounting frame 100 which is mounted on the wall surface due to the engagement of the engaging member xx6 and the engaging member 100H2. Further, to ensure the sufficient strength against strong wind, the display module xx is firmly fixed to the module mounting frame 100 by the mutual screwing of display modules xx using the screw parts xx8, xx9.

### Embodiment 11

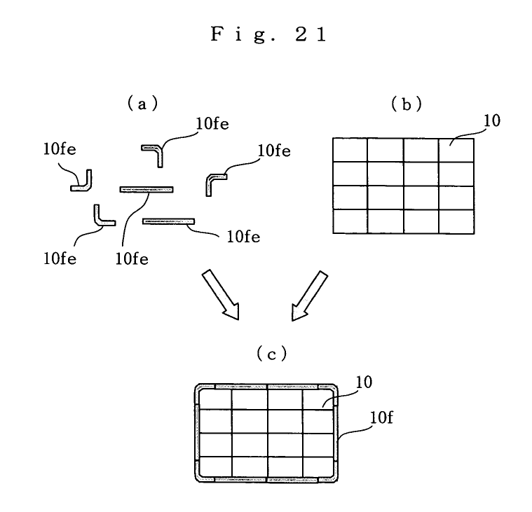

Hereinafter, an embodiment 11 of the present invention is explained in conjunction with FIG. 20A and FIG. 20B. FIG. 20A and FIG. 20B are longitudinal cross-sectional right side views with a part in cross section showing a part in cross section by enlarging another example of a display module fixing means particularly in a state before the display modules are assembled in the large-sized display device. In FIG. 20A and FIG. 20B, parts which are identical with or correspond to the above-mentioned parts shown in FIG. 1 to FIG. 19 are given same symbols. Hereinafter, points which make this embodiment 11 different from the above-mentioned embodiments 1 to 10 shown in FIG. 1 to FIG. 19 are mainly explained.

FIG. 20A and FIG. 20B show an example in which, as described in the above-mentioned JP-A-2004-341468, the respective display modules xx are inclined and portions of panel-like display devices xx1, xx1 which are arranged close to each other are arranged in a partially overlapped manner, and a module detachable mechanism which is manipulable from a gap between overlapped portions of both panel-like display devices xx1, xx1 is provided. This embodiment includes a detaching part (mounting means) xx10 provided with an interlocking mechanism illustrated in FIG. 20A and a fastening part (mounting means) xx11 using a screw which is arranged close to the detachable part and is illustrated in FIG. 20B. Due to the provision of such duplicate detaching mechanisms, even in the structure where the panels are arranged to be overlapped to each other, it is possible to realize the easy maintenance and the high reliability. Here, the detaching parts xx10 and the fastening part xx11 may be equal to corresponding parts described in the above-mentioned JP-A-2004-341468 and hence, the explanation of the specific structure and the manner of operation of these parts is omitted.

### Embodiment 12

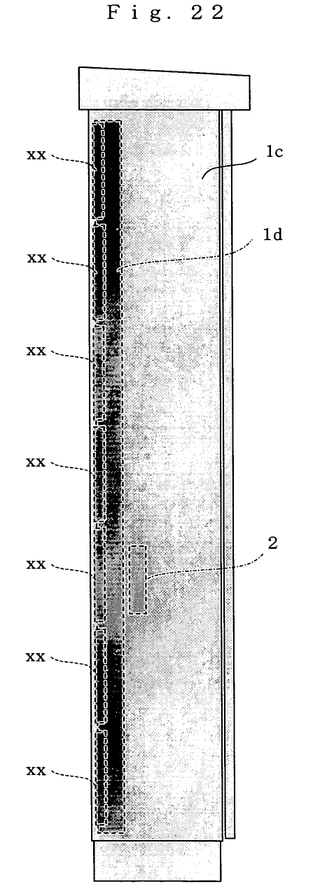

Hereinafter, an embodiment 12 of the present invention is explained in conjunction with FIG. 21A to FIG. 21C. FIG. 21A to FIG. 21C are exploded views of an example of another large-sized display device, wherein FIG. 21A is a front view showing a state in which a waterproof frame is disassembled, FIG. 21B is a front view of a display screen part, and FIG. 21C is a front view showing a state in which the waterproof frame is mounted on an outer periphery of the display screen part. In FIG. 21A to FIG. 21C, parts which are identical with or correspond to the above-mentioned parts shown in FIG. 1 to FIG. 20B are given same symbols. Hereinafter, points which make this embodiment 12 different from the above-mentioned embodiments 1 to 11 shown in FIG. 1 to FIG. 20B are mainly explained.

The above-mentioned display device 1 in the embodiment 1 of the present invention is constituted by assembling the display modules xx in the frame 1f which is preliminarily fixed to the display device mounting structure 6 having the sufficient strength. In the same manner as the assembling of such display modules, it is possible to mount a collapsible frame body 10f on a periphery at the time of assembling the display screen 10. While the conventional frame determines a design of the display device as shown in FIG. 22, this embodiment 12 shows an example in which the collapsible frame body 10f which is constituted of a plurality of frame body constituting members 10fe is mounted on the periphery of the display screen 10. The collapsible frame body 10f can form the light-weighted and arbitrary design. Particularly, it is possible to change only the frame body 10f after installing the display device. Accordingly, it is possible to arbitrarily change the design of the display device 1.

While the presently preferred embodiments of the present invention have been shown and described, it is to be understood that these disclosures are for the purpose of illustration and that various changes and modifications may be made without departing from the scope of the invention as set forth in the appended claims.

What is claimed is:

1. An assembling method of a display device in which a display screen is constituted of a plurality of display modules, wherein the display device is assembled by
a water proof frame mounting step which mounts a waterproof frame on a display device mounting structure, and
a display screen assembling step which assembles the display screen whose periphery is covered with the waterproof frame mounted on the display device mounting structure using a plurality of display modules.

2. An assembling method of a display device according to claim 1, wherein the respective display modules are detachably mounted on the waterproof frame by way of the module mounting frame.

3. An assembling method of a display device according to claim 2, wherein the respective display modules are detachably mounted on the display device mounting structure by way of the module mounting frame.

4. An assembling method of a display device in which a display screen is constituted of a plurality of display modules, wherein the display device is assembled by
a module mounting frame mounting step which mounts a module mounting frame on a display device mounting structure,
a display module mounting step which mounts the display modules on the module mounting frame, and
a display screen constituting step which constitutes the display screen using the plurality of display modules by exercising the display module mounting step plural times.

5. A display device comprising:
at least one module mounting frame which is mounted on a display device mounting structure;
a plurality of display modules which are detachably mounted on the module mounting frame and constitute a display screen;
a signal cable which has a wiring route in the inside of the module mounting frame and is detachably connected to the display modules and supplies image signals to the display modules; and
a power source cable which has a wiring route in the inside of the module mounting frame and is detachably connected to the display modules and supplies electric power to the display modules.

6. A display device according to claim 5, wherein the module mounting frame is a grid-like frame and the plurality of display modules are detachably mounted on beams of the grid-like frame.

7. A display device according to claim 5, wherein the module mounting frame is constituted of a plurality of ladder-like frames and the plurality of display modules are detachably mounted on beams of the ladder-like frames.

8. A display device according to claim 5, wherein the module mounting frame is constituted of a plurality of picture-frame-like frames and the display modules are detachably mounted on beams of the picture-frame-like frames.

9. A display device according to claim 5, wherein the display device mounting structure is a mounting base and the module mounting frame is mounted on the mounting base by way of a plurality of support bodies on the mounting base.

10. A display device according to claim 9, wherein a maintenance door is formed on a back surface side of the display device in a state that the inside of the display device is exposed to the outside through the back surface side along with the opening of the maintenance door.

11. A display device according to claim 5, wherein the display device mounting structure is a wall of a building and the module mounting frame is mounted on a wall surface of the wall.

12. A display device according to claim 5, wherein at least one of a display controller which controls an image display of the whole display screen of the display device and a power source device is mounted on the display device mounting structure.

13. A display device according to claim 5, wherein the display device of the display module is a reflective display device.

14. A display device according to claim 5, wherein the display device of the display module is cholesteric liquid crystal.

15. A display device according to claim 5, wherein each display module includes a LAN interface, a display controller which controls an image display of the whole display screen of the display device and the LAN interfaces of the respective display modules are connected with each other by a LAN cable, and image control signals are supplied to the respective display modules from the display controller by way of the LAN cable and the LAN interfaces.

16. A display device according to claim 5, wherein the respective display modules have both opposing side portions thereof detachably mounted on the module mounting frame.

17. A display device according to claim 16, wherein the mounting of each display module on the module mounting frame is performed by a mounting means based on engagement at one of the opposing side portions, and the mounting of each display module on the module mounting frame is performed by a mounting means based on screwing at another of the opposing side portions.

18. A display device according to claim 16, wherein the mounting of each display module on the module mounting frame is performed by a mounting means based on fitting engagement at one of the opposing side portions, and the mounting of each display module on the module mounting frame is performed by a mounting means based on interlocking engagement at another of the opposing side portions.

19. A display device according to claim 18, wherein on the same side as mounting means based on interlocking engagement of each display module, the mounting of each display module on the module mounting frame is performed by a mounting means based on screwing.

20. A display device according to claim 5, wherein the display device includes a frame body which surrounds a periphery of a display screen which is constituted of the plurality of display modules, and the frame body is constituted of a plurality of frame body constituting members which are arranged in the peripheral direction of the frame body.
